(19) United States
(12) Patent Application Publication
(10) Pub. No.: US 2017/0145816 A1
(43) Pub. Date: May 25, 2017

(54) TELEMETRY BOOSTER

(71) Applicant: SCHLUMBERGER TECHNOLOGY CORPORATION, Sugar Land, TX (US)

(72) Inventors: Miguel F. Pabon, Katy, TX (US); Gaelle Jannin, Katy, TX (US)

(21) Appl. No.: 15/355,965

(22) Filed: Nov. 18, 2016

Related U.S. Application Data
(60) Provisional application No. 62/257,605, filed on Nov. 19, 2015.

(51) Int. Cl. E21B 47/12; E21B 47/18; H04B 3/36

(52) U.S. Cl. CPC E21B 47/122; H04B 3/36; E21B 47/18; H04B 2001/6908

(57) ABSTRACT

An information-carrying acoustic-pressure wave is generated in a wellbore using mud pulse telemetry. The information-carrying acoustic-pressure wave is converted, downhole, into an information-carrying electromagnetic wave and that wave is transmitted to the surface where it is received and the information extracted. A downhole repeater converts the acoustic-pressure wave and transmits the electromagnetic wave. The signal is received by an uphole/surface receiver. The repeater and/or the surface receiver may use an insulating gap. The electromagnetic signal is modeled as a leaky and noisy electronic circuit and the modeling results are used to select a spread spectrum transmission technique. The selected spread spectrum transmission technique is used to transmit the information-carrying electromagnetic signal at an increased rate of data transmission. The electronic noise and/or loss of signal energy are mitigated and a maximum transmission distance of the information-carrying electromagnetic signal is estimated using the modeling results.

### CROSS-REFERENCE TO RELATED APPLICATIONS

This application claims the benefit of U.S. Provisional Application No. 62/257,605, filed Nov. 19, 2015.

### BACKGROUND OF THE DISCLOSURE

To drill a well, one generally uses tubulars (e.g., drill pipe) to rotate a drill bit. While rotating the drill pipe, drilling fluid (mud) is circulated in the borehole to, among other things, lubricate the bit, remove rock cuttings, and control the pressure in the wellbore. Existing bottomhole assemblies (BHAs) generally include a telemetry system to send information regarding selected drilling parameters and rock properties to the surface while the well is being drilled. Such telemetry is achieved by modulating a pressure pulse created by closing or choking a valve system, typically located a few tens of feet (a few meters) above the bit, which is in the circulatory path of the mud pumped from the surface. Such “mud pulse telemetry” is widely used in the industry and works by detecting the generated pressure pulses propagated towards the surface with a gauge connected to the mud line at the rig. Different modulations (sequence of pressure pulses) are often used to carry the information from the bottom of the hole along the drill pipe and to the surface mud line.

Current communication rates achieved are on the order of a few (e.g., 1-10) bits per second. Some of the reasons for such low rates are: (1) length of the well: the farther the distance, the more mud pressure pulse attenuation; (2) losses related to the type of mud: pulse propagation depends on the density and viscosity of the mud in the mud column—the heavier the mud and the more viscous, the more it will attenuate a pressure wave; (3) pressure wave propagation losses due to frequency: the earth, being a natural “low pass” filter, tends to attenuate the higher frequencies more than the lower ones; (4) noise from sources near the receiving section: at the surface, the noise created by the mud pumps is subtracted from the signal detected at the “listening” pressure gauge; and (5) other electrical noise: this may be noise associated with the amplifiers and cables connecting the rig to the demodulation station such as an electrical module connected to a computer.

In typical offshore environments (but this also applies to very cold land areas), the temperature profile goes from ambient (surface) temperature to cooler temperatures as water depth increases, reaching almost zero degrees Celsius near the sea bottom. As one proceeds deeper into the wellbore, temperature begins to increase and finally equilibrates to the geothermal gradient of the area. FIG. 1 is a plot showing an example temperature profile of a deep sea well along with a corresponding true-vertical-depth wellbore profile. As we drill in deeper and deeper water depths, the temperature differential creates a cooling mechanism on the mud being pumped during drilling. The temperature-sensitive viscosity of the mud can become a major attenuation factor for pressure pulse waves propagating from the bottom of a well.

Various attempts have been made to cope with the smaller pressure pulse signals. One technique is to decrease the telemetry frequencies, but that also tends to decrease the data rate. That is generally unacceptable since the speed of updated information affects an operator's ability to make timely drilling decisions. Other methods try to compensate by increasing the pressure pulse amplitude at the source. Still others use alternative transmission systems such as electromagnetic wave propagation. However, at least in the offshore environment, it is not yet possible to implement such systems in a practical way.

### SUMMARY

Techniques described in the present disclosure relate to systems and methods for generating an information-carrying acoustic-pressure wave in a wellbore using mud pulse telemetry. The information-carrying acoustic-pressure wave is converted, downhole, into an information-carrying electromagnetic wave and that wave is transmitted to the surface where it is received and the information extracted. A downhole repeater converts the acoustic-pressure wave and transmits the electromagnetic wave. The signal is received by an uphole/surface receiver. The repeater and/or the surface receiver may use an insulating gap. The electromagnetic signal is modeled as a leaky and noisy electronic circuit and the modeling results are used to select a spread spectrum transmission technique. The selected spread spectrum transmission technique is used to transmit the information-carrying electromagnetic signal at an increased rate of data transmission. The electronic noise and/or loss of signal energy are mitigated and a maximum transmission distance of the information-carrying electromagnetic signal is estimated using the modeling results.

One or more embodiments additionally relate to modeling an electromagnetic signal as a leaky and noisy electronic circuit, using the modeling results to select a spread spectrum transmission technique, and transmitting an information-carrying electromagnetic signal using the selected spread spectrum transmission technique.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Embodiments are described with reference to the following figures. The same numbers are generally used throughout the figures to reference like features and components.

FIG. 1 is a plot showing an example temperature profile of a deep sea well along with a corresponding true-vertical-depth wellbore profile, in accordance with the present disclosure.

FIG. 2 is a plot showing the viscosity change versus temperature for typical drilling muds, in accordance with the present disclosure.

FIG. 3A is a schematic drawing of one embodiment of a telemetry booster system in a well in which a repeater system is installed so as to operate between point B and the surface (point A), in accordance with the present disclosure.

FIG. 3B is a schematic drawing showing elements of FIG. 3A in expanded view, in accordance with the present disclosure.

FIG. 4 is a schematic drawing of an electric model that considers that the repeater as a voltage source, in accordance with the present disclosure.

FIG. 5 is a schematic drawing of a basic model that may be used by electromagnetic wave propagation software to estimate the extent of losses suffered in an ideal scenario, in accordance with the present disclosure.

FIG. 6 is a graph showing, for various frequencies, the current attenuation for a 1 amp current sourced at a repeater in water base mud, in accordance with the present disclosure.

FIG. 7 is a graph showing, for various frequencies, the current attenuation for a 1 amp current sourced at a repeater in two different oil base muds, in accordance with the present disclosure.

FIG. 8 is a schematic drawing illustrating the use of a spread spectrum transmission technique operating in four frequencies, in accordance with the present disclosure.

FIG. 9 is a schematic drawing showing the elements of one embodiment of the surface equipment used in accordance with the present disclosure.

FIG. 10 is a schematic drawing showing the elements of one embodiment of the downhole equipment used in accordance with the present disclosure.

FIG. 11 is a flowchart showing one embodiment of telemetering data out of (and into) a wellbore, in accordance with the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate. It will also be understood that, although the terms first, second, etc. may be used herein to describe various elements, these elements should not be limited by these terms. These terms are only used to distinguish one element from another.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

A system and method to telemeter data out of (and into) a wellbore is disclosed. In particular, the data rate of communication between a telemetry module located in a bottomhole assembly (BHA) and a surface detection system located on a rig site is improved. The system bridges the losses associated with pressure pulsing across the thousands of feet (meters) which may include the upper portion of a well. These losses are much greater near the surface due to the difference between the earth's surface temperature and the temperatures near the lower end of the well, which is exposed to geothermal gradients. Information coming from a BHA telemetry mud pulsing module at or near the “toe” of the well is received by another telemetry module located at or near the “ankle” of the well (e.g., close to the intermediate casing depth). That telemetry module (or a different type of telemetry module substantially co-located at the ankle and in communication with the other co-located telemetry module) sends the same (i.e., received) information towards the surface rig in a manner designed to avoid the losses due to viscosity changes in the drilling fluid. This results in a boost in the overall telemetry rate.

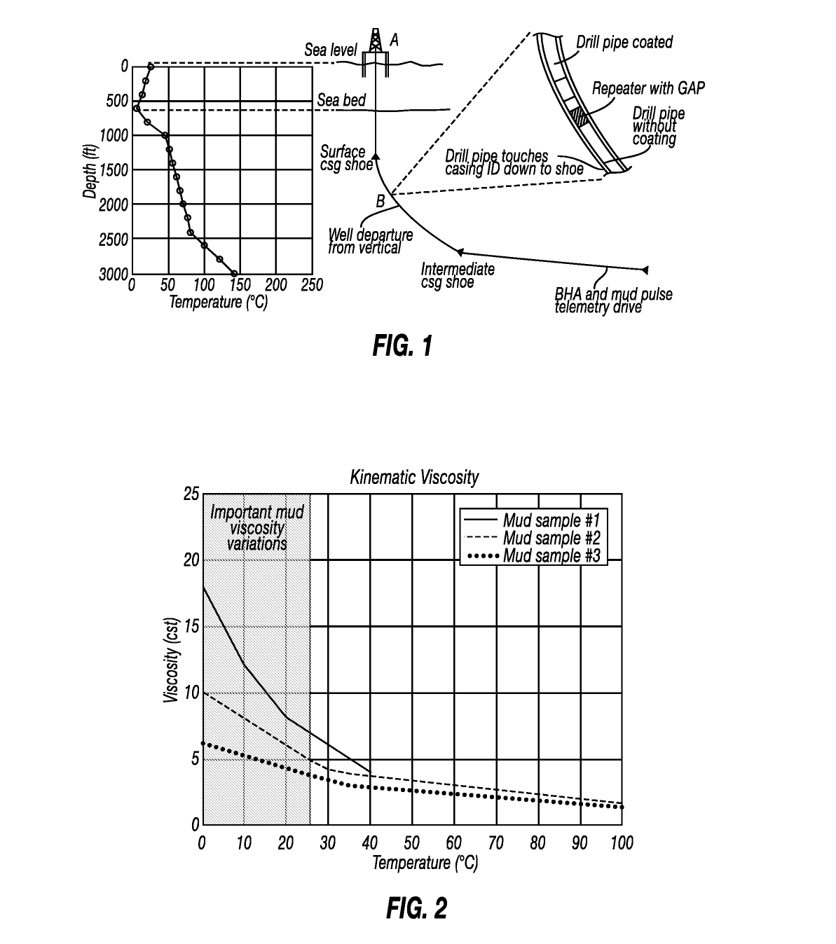

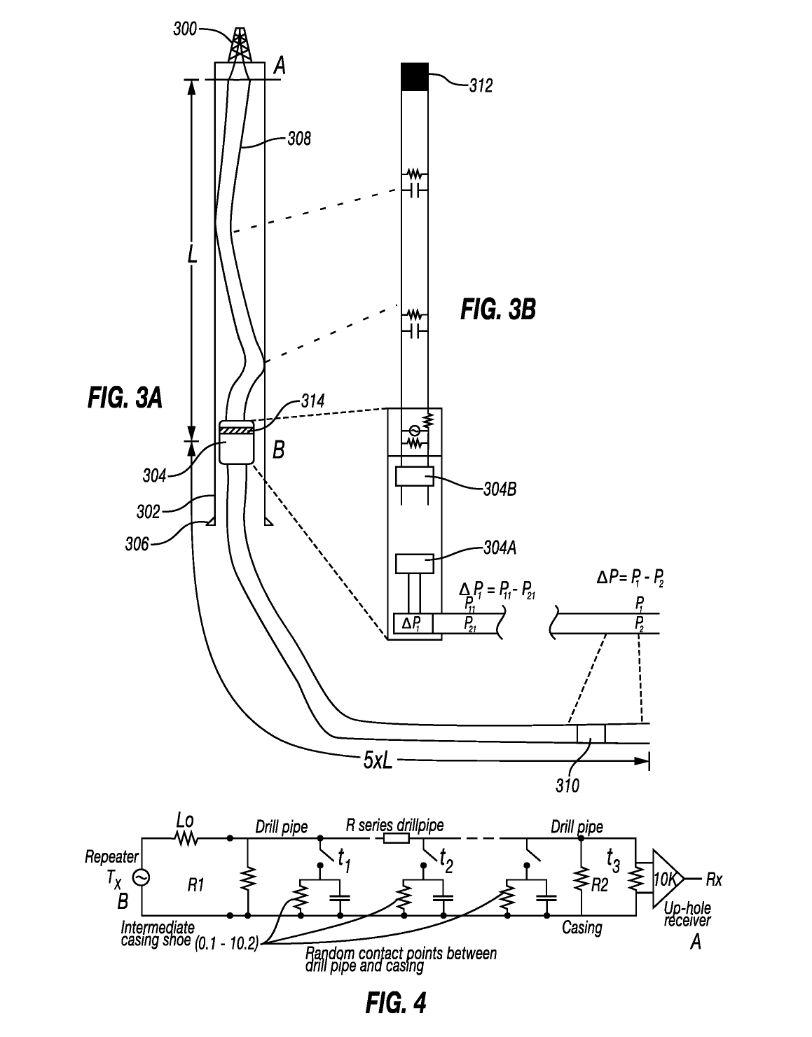

The interval in which the most up-going pressure wave energy is lost is generally between the surface (see point A, FIG. 1 or 3) and the subsurface region at which the geothermal gradient becomes fairly well established (see point B, FIG. 1 or 3). That is generally due to the temperature differences and the corresponding effects of temperature on viscosity, which in turn affects acoustic-pressure wave attenuation. While the distance from point B to the lowest mud pulse telemetry unit (i.e., nearest the drill bit) may be quite long, the changes in mud viscosity over that distance has less of an attenuative effect since the temperature variation is relatively small. Thus, efficiencies may be gained by focusing on the interval from point B to point A. FIG. 2 is a plot showing the viscosity change versus temperature for typical drilling muds.

FIG. 3A is a schematic drawing of one embodiment of a telemetry booster system in a well in which a repeater system is installed so as to operate between point B and the surface (point A). The well sketch, not to scale, shows a rig 300, an intermediate casing 302, and a repeater sub 304 (with a GAP) located close to the end of an intermediate casing shoe 306. The distance L extends from the drill floor down to the repeater location. This is the distance between B and A and may be between 1000 to 5000 feet (300-1524 meters). Note that FIG. 3A shows the drill pipe 308 “rubs” the casing 302 internal wall at two points. The rest of the well drawing shows the landing (i.e., deviated section—in this and most other cases, it ends horizontally). For purposes herein, one may consider the distance from the repeater 304 to the end of the well as up to five times the distance L (i.e., 5×L).

Shown near the bottom of the well is a conventional mud pulse telemetry unit 310. Mud pulse telemetry unit 310 creates pressure waves that propagate in the mud towards the surface, as is known in the art. FIG. 3B is a schematic drawing showing elements of FIG. 3A in expanded view. FIG. 3B illustrates the functional relationship between the mud pulse telemetry unit 310 and repeater 304. In operation, the mud pulse telemetry unit 310 creates a wave pulse ΔP=P1-P2. This pressure pulse propagates uphole and reaches the repeater 304, albeit with lower amplitude due to energy losses along the way. The received signal is labeled as ΔP1=P11-P21. Repeater 304, either through separate or integrated components (e.g., repeater elements 304A and 304B), receives signal ΔP1 and translates/converts the pressure wave data into electromagnetic (EM) signals. Those EM signals travel to the rig and are detected by a top-side receiver 312.

More specifically, repeater 304 is deployed downhole as part of the drill string 308 and begins to operate once it reaches some desired wellbore depth (e.g., point B or somewhere in the vicinity of intermediate casing shoe 306). As the drilling process continues, repeater 304 receives the pressure pulses 4P1 from telemetry sub 310 and de-modulates them, so as to extract the actual data encoded in the pressure pulse wave. Repeater 304 then broadcasts an EM signal, thereby creating an electromagnetic field inside casing, by applying a voltage difference across an insulating sub 314 (called a “GAP”) that is integral to repeater 304. The voltage difference across the GAP 314 creates a current going from the lower side of the GAP 314, into the casing 302 along the casing wall, and then across the annular space between drill pipe 308 and casing 302, back into the upper side of the GAP 314. The current will propagate upwards, but decreases in intensity as the length of the conduction path increases. Given sufficient initial energy and not suffering too much transmission loss, the EM signal will reach the surface where the top-side receiver 312 will pick it up.

The top-side receiver 312 is located at or near rig level, such as directly below the top drive (point A), and generally has mechanical properties similar to a top drive adapter. Integral to or near the top drive is another insulating sub (often called a “top-GAP”) (not shown). The top-side receiver 312 has electronics that detect a voltage signal between the drill pipe 308 and the top drive adapter, which has the same electrical potential as the whole rig/platform/ship. The electrical currents that propagate between the drill pipe 308 and casing 302 between points B and A generate small voltages that are detected, amplified, and transmitted from the top-side receiver 312 to a demodulation unit located near the rig 300.

Recent field test experience with EM telemetry tools in land operations shows that, although one might think that the drill pipe, as it contacts the casing, would electrically short to the casing inner surface along the distance B-A, that condition is not a persistent effect. In reality, while the pipe “rubs” against the casing, the resulting electrical contact is far from solid/continuous. Furthermore, one could envisage several methods to insulate one or both of the rubbing surfaces, such as painting the drill pipe with an insulating coating or coating the casing inner wall surface with a similar material. Also, one could strategically position insulating shields installed on the pipe-joints. For example, shields could be made of plastic (e.g., high-density polyethylene or similar material). There is little risk of these materials compromising the drilling process because, if they break off, the broken pieces can be recovered in the cuttings return, particularly if the material is of lower density than the drilling fluid.

The field test results suggest an electric model that considers that the repeater 304 as a voltage source. FIG. 4 is a schematic drawing of one such model. Drill pipe 308 serves as a conductive leg on one side of the repeater (voltage source) 304, and casing 302 serves as a conductive return leg on the other side of the repeater 304. The top-side receiver 312 completes one possible current loop. Because the annulus is filled with drilling fluid, there is potentially some current leakage through the mud from one conductive leg to the other (e.g., from the drill pipe 308 to the casing 302). Such a current path can be modeled as a resistive element spanning the annulus, such as resistor R1 or R2 in FIG. 4. To account for the random, transient contact point “shorts” between the drill pipe 308 and casing 302, one may use a switch wired in series with a resistor and capacitor that are wired in parallel, as shown in FIG. 4. Three such modeled shorts are shown, with the switches operating at different times (t1, t2, t3).

In an idealized scenario, the drill pipe 308 would not touch the casing inner wall. For the model of FIG. 4, the circuit will have the switches in their OFF position all the time. Current propagates along the “wire” represented by the drill pipe and returns through the casing wall. Drill pipe 308 and casing 302 are basically steel with a very low resistivity value (˜10E-06 ohm-m). In between those two we have a lossy medium dominated by the mud resistivity (e.g., R1, R2). The resistances R1, R2 depend in part on the resistivity of the drilling mud (i.e., ˜1 to 3 ohm-m in water base mud, >1000 ohm-m in oil base mud), the drill pipe outer diameter, the casing inner diameter, and the path length L. However, those resistivities also depend largely on the temperature of the fluid. Thus, in this scenario, the current that propagates above the repeater 304 travels along the drill pipe 308 to the top-side receiver 312 and across the annular space. If one produces enough current at point B or operates in an electrically benign environment (e.g., oil-base mud), one could send data at high speed to the top-side receiver 312 at point A.

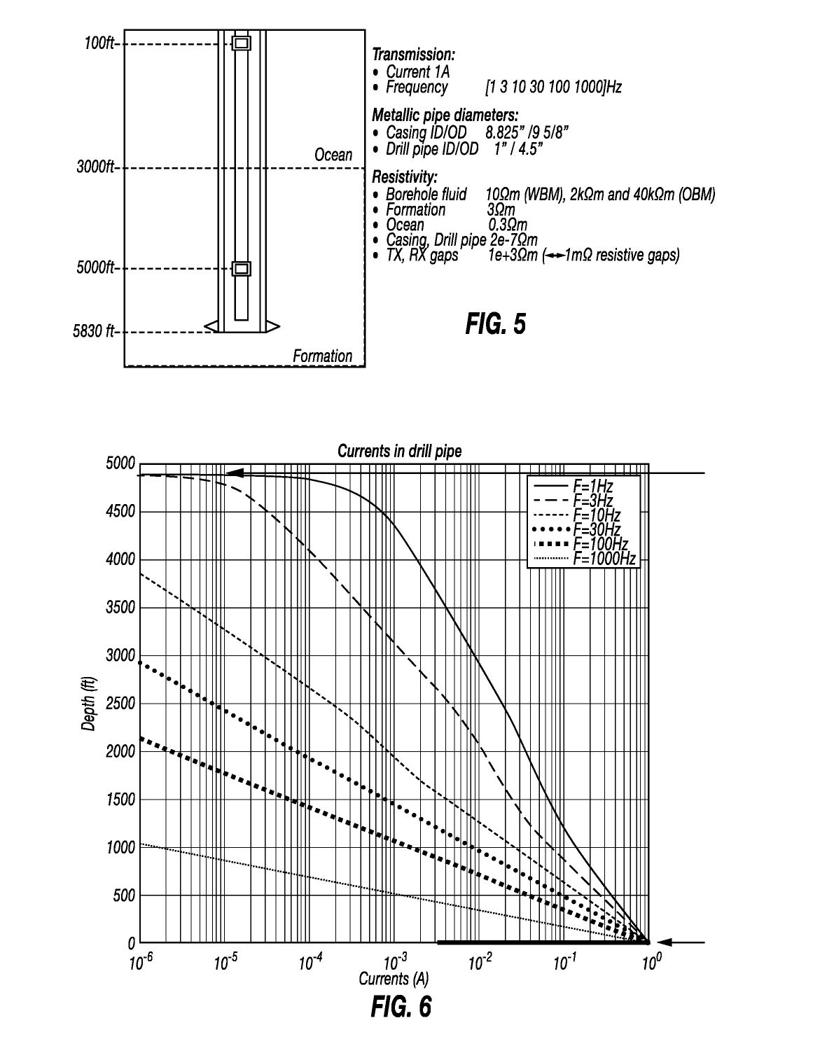

To estimate the extent of losses suffered in the ideal scenario, EM wave propagation software may be used. FIG. 5 is a schematic drawing of a basic model that may be used. FIG. 5 shows a repeater 304 at 5000 feet (1524 meters). A top-side receiver 312 is shown at 100 feet (30 meters), though in reality it may be above sea level at or just below the platform top drive. However, for the purpose of this modeling, this is essentially the same. Casing surrounds the top-side receiver 312 and the intermediate casing shoe 306 is at 5830 feet (1777 meters). The ocean depth is 3000 feet (914 meters). Various other parameter values are shown in FIG. 5, such as resistivity values for the ocean and formation that are typical for these environments and depths. Note, sea water does not enter the annular space between the drill pipe and the casing. The borehole fluid is mud of given resistivity.

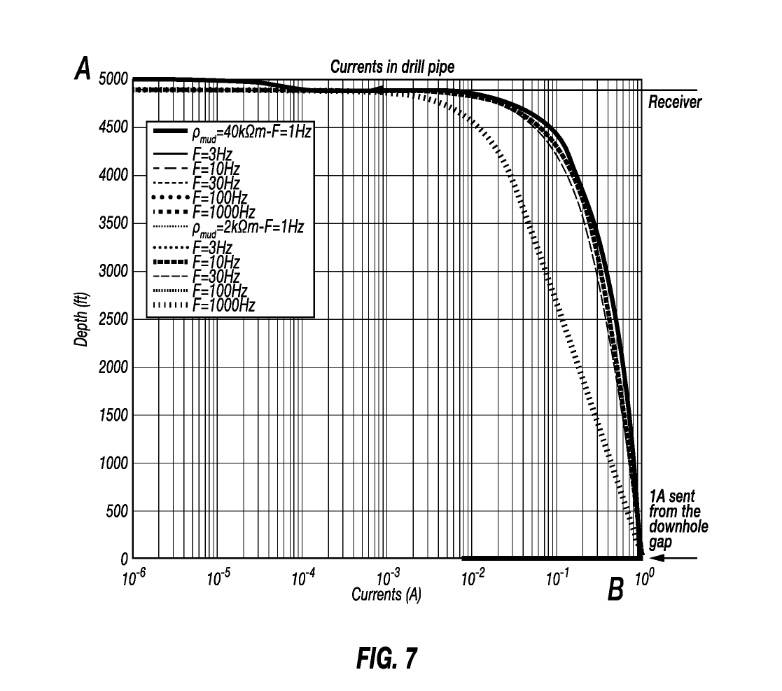

Three cases were investigated: one using water base mud (10 ohm-m at surface) and two using oil base muds of different resistivities (2 kOhm-m and 40 kOhm-m at surface). FIGS. 6 and 7 are graphs showing, for various frequencies, the current attenuation for a 1 amp current sourced at the repeater 304 in water base mud and oil base muds, respectively. FIG. 6 shows the current in the drill pipe 308 at different depths in water base mud. In this case, depth “0 feet” refers to the position of the repeater 304 (point B). As we go up the wellbore in depth, ideally towards point A, the original source current of 1 amp decreases. The attenuation increases as we progress up the wellbore. Also, the attenuation is larger for higher frequencies. For instance, we register a 1 micro-amp current level for a 10 Hz signal at 3800 feet (1158 meters) above the point B, but, for a 1000 Hz signal, the same current level is registered 1000 feet (305 meters) above the same point B. It is apparent that with water based mud the losses will generally be too high for a signal to reach a receiver a total distance of 5000 feet (1524 meters) away. By operating at very low frequencies such as 1 Hz one can envisage having a reasonable signal at selected distances in water base mud.

To obtain the results shown in FIG. 7, we used the same modeling geometry as that shown in FIG. 5. In this case the two different drilling fluids are both oil base muds, but with different resistivities. Compared to water base mud, both of these muds have high resistivity, hence the leakage of signal is vastly reduced. Notice that the current levels off at about 1 mAmp at 4800 feet (1463 meters) above point B for all frequencies and both mud resistivities (2 kΩ-m and 40 kΩ-m). Thus, even in the ideal case where the drill pipe 308 does not touch the casing 302 inner wall, there can be considerable signal attenuation. However, if one operates in oil base mud, which is the case for many offshore wells, the signal is sufficiently large to be detected by a high-gain receiver.

A more realistic scenario is one in which drill pipe 308 touches the inner wall of casing 302 at different points and at different times. Despite preventative measures such as coating the drill pipe 308 with insulating material, installing centering, insulating plastic covers over certain drill pipe joints, or coating the casing internal walls, the drill pipe 308 will almost certainly touch the casing 302 inner wall, establishing a metal-to-metal short-circuit to the upward propagating current. As stated above, this is represented in FIG. 4 by the switches t1, t2, and t3 closing at different times, shorting the circuit at different depths. Because of the random nature of the contact, there is no effective way to control the number of switches or the times at which they switch ON. To compensate for the transient grounding, one may use a spread spectrum transmission to overcome the signal loss caused by the drill pipe 308 touching the casing 302.

Prior art mud pulse telemetry sends information in the range of one to ten bits per second (bps). If, for instance, the baud rate is four bps (i.e., 4 baud), in one hour (3600 seconds) a total of 14,400 bits can be transmitted. By using a spread spectrum transmission technique such as frequency-hopping spread spectrum, direct-sequence spread spectrum, time-hopping spread spectrum, or chirp spread spectrum, one could send the same data, but would likely double the data package in order to add “overhead information” such as error correction codes, check sum codes, and time labels. That additional data decreases the chance of the data being lost due to high noise.

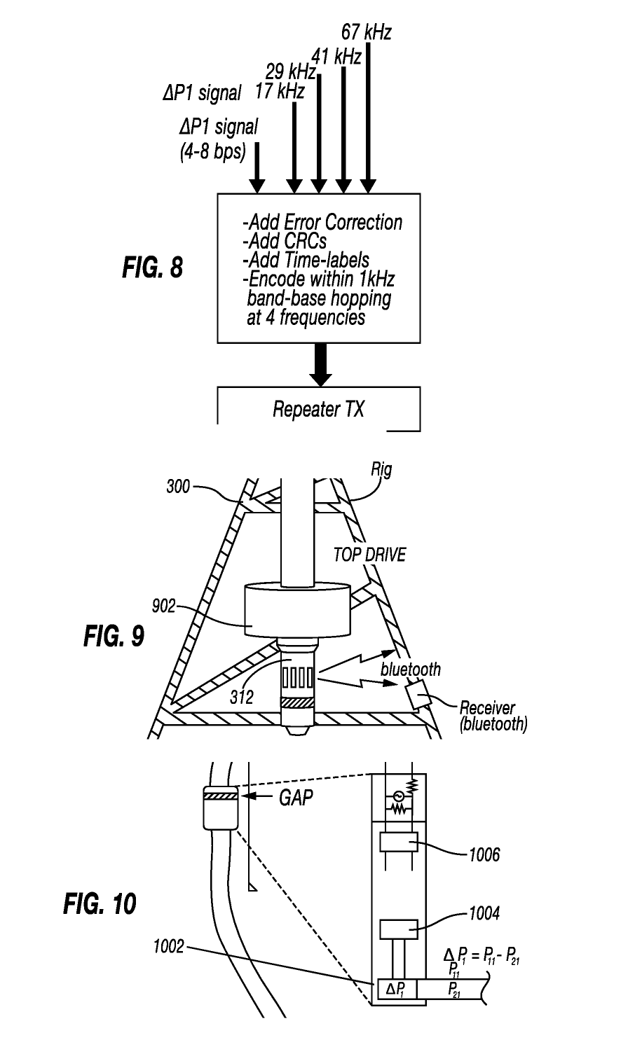

If, however, one simultaneously transmits the same message at four different high frequencies, encoded on a baseband of, say, one kHz, one could send the same hour's worth of data in approximately 58 seconds. Using four different frequencies helps the system become insusceptible to the noise created by the multiple, transient shorting of the drill pipe 308 to the casing 302 wall. This is similar to techniques used in military radios to reconstruct data in presence of random jamming signals. A surface system operating in the known four frequencies to reconstruct the same message from four tuned frequencies can decode the up-going information in real time. FIG. 8 is a schematic drawing illustrating the use of such a spread spectrum transmission technique. Because of the vastly improved de-coding time, this system could re-try to decode the data 59 more times within the course of one hour before effects of latency or lost information are incurred.

One embodiment of such a system includes, for the uphole equipment, a GAP sub such as a top-side receiver 312 connected to a top drive 902 (see FIG. 9). Alternatively a sub wound antenna could be used. The top-side receiver 312 comprises electronics to demodulate the signal and transmit results via a wired or wireless transmission system. Power may be supplied by the rig or it may use batteries. Pressure and pipe extension/compression ratings are identified. FIG. 9 is a schematic drawing showing the surface elements of such an embodiment.

Similarly, for the downhole portion, a GAP drill pipe sub such as repeater 304 is employed, as shown in FIG. 10. Repeater 304 has electronics that may operate on batteries, though a downhole electrical generator (not shown) could also serve as a power source. A pressure sensor 1002 to detect pressure waves is included, along with a receiver processing unit (CPU Rx) 1004 and a transmitter processing unit (CPU Tx) 1006. As an example, for a mission profile with temperatures less than 100 degrees Celsius and a path length L less than 5000 feet, one could generally use devices with 10 Kpsi ratings. As mentioned above, one could add drill pipe joint insulators to mitigate pipe rub against casing. Such insulators may be placed closer to the repeater 304.

If the well depth continues to increase, one could add another repeater unit 304 in the drill string 308. At a convenient time/depth, one could put the first (deeper) repeater to “sleep” and “wake up” the shallower unit. Further receiving capabilities for the downhole repeater and transmitting capabilities for the uphole sub could be added. That would allow one to “downlink” to the repeater or do transmission sweeps to determine optimal operating bands. If the downhole demodulation is successful and reliable, one could push higher mud pulse bit rates at the BHA, thus enhancing the overall throughput.

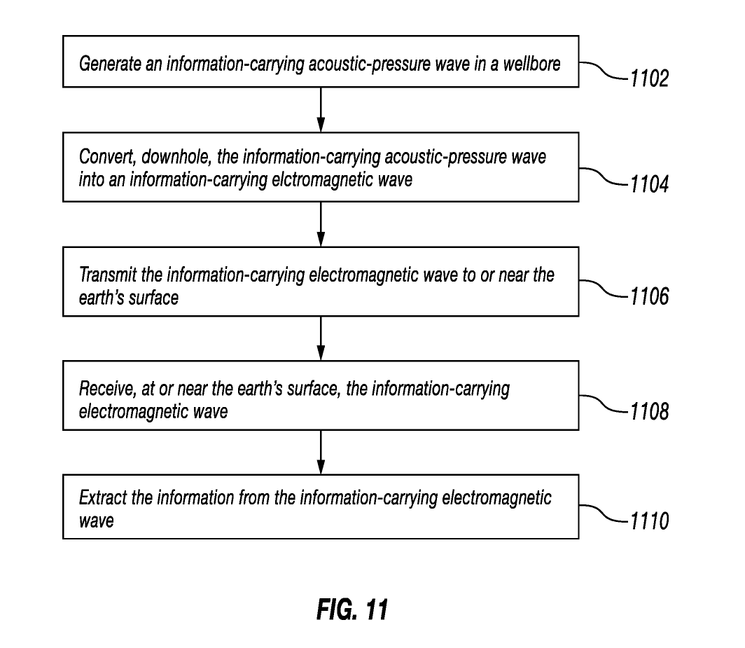

FIG. 11 is a flowchart showing one possible embodiment to telemeter data out of (and into) a wellbore. In this embodiment, an information-carrying acoustic-pressure wave in a wellbore is generated (1102). The information-carrying acoustic-pressure wave is converted, downhole, into an information-carrying electromagnetic wave (1104). The information-carrying electromagnetic wave is transmitted to or near the earth's surface (1106). At or near the earth's surface, the information-carrying electromagnetic wave is received (1108) and the information from the information-carrying electromagnetic wave is extracted (1110).

While embodiments described herein have focused on applications in the oilfield service industry, other applications are possible and contemplated.

Some of the methods and processes described above, including processes, as listed above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, and alterations herein without departing from the scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

While certain embodiments have been set forth, alternatives and modifications will be apparent from the above description to those skilled in the art. These and other alternatives are considered equivalents and within the scope of this disclosure and the appended claims. Although a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
generating an information-carrying acoustic-pressure wave in a wellbore;
converting, downhole, the information-carrying acoustic-pressure wave into an information-carrying electromagnetic wave;
transmitting the information-carrying electromagnetic wave to or near the earth's surface;
receiving, at or near the earth's surface, the information-carrying electromagnetic wave; and
extracting the information from the information-carrying electromagnetic wave.

2. The method of claim 1, wherein the converting comprises receiving and processing the information-carrying acoustic-pressure wave.

3. The method of claim 2, wherein the processing of the information-carrying acoustic-pressure wave comprises de-coding the acoustic-pressure wave and encoding the electromagnetic wave.

4. The method of claim 1, further comprising mitigating noise in the information-carrying electromagnetic wave.

5. The method of claim 1, wherein the transmitting of the information-carrying electromagnetic wave comprises applying a voltage across an insulating gap.

6. The method of claim 1, wherein the transmitting of the information-carrying electromagnetic wave comprises using a spread spectrum transmission technique.

7. The method of claim 6, wherein the spread spectrum transmission technique is selected from a group consisting of: frequency-hopping spread spectrum, direct-sequence spread spectrum, time-hopping spread spectrum, and chirp spread spectrum.

8. The method of claim 6, further comprising simultaneously transmitting an identical signal on multiple waves carried on a carrier wave, wherein each of the multiple waves has a frequency different from the other multiple waves and the carrier wave has a frequency lower than any of the multiple waves.

9. The method of claim 1, wherein the receiving of the information-carrying electromagnetic wave comprises detecting a voltage across an insulating gap or induced in a sub wound antenna.

10. A system, comprising:
a wellbore, at least a portion of which is lined with a casing;
an acoustic-pressure wave generator disposed in the wellbore;
a downhole repeater disposed in the wellbore upstream of the acoustic-pressure wave generator;
an uphole receiver located at or near the earth's surface; and
a drill string linking the uphole receiver, the downhole repeater, and the acoustic-pressure wave generator.

11. The system of claim 10, wherein the downhole repeater, an upper portion of the drill string, the uphole receiver, and the casing form an electric circuit.

12. The system of claim 10, further comprising an oil base drilling fluid disposed in the wellbore.

13. The system of claim 10, wherein the acoustic-pressure wave generator is located near a lower end of the drill string, the downhole repeater is located near a lower end of the casing, and the uphole receiver is located near a top drive.

14. The system of claim 10, wherein the downhole repeater comprises a pressure sensor, a receiver processor, a transmitter processor, and an insulating gap; and the uphole receiver comprises a sub having an insulating gap or a sub wound antenna.

15. The system of claim 10, further comprising one or more electrically insulating materials disposed on at least a portion of an upper portion of the drill string and/or at least a portion of an inner wall of the casing.

16. A method, comprising:
modeling an electromagnetic signal as a leaky and noisy electronic circuit; and
using the modeling results to select a spread spectrum transmission technique;
transmitting an information-carrying electromagnetic signal using the selected spread spectrum transmission technique.

17. The method of claim 16, further comprising mitigating the electronic noise and/or loss of signal energy using the modeling results.

18. The method of claim 16, further comprising estimating a maximum transmission distance of the information-carrying electromagnetic signal using the modeling results.

19. The method of claim 16, further comprising increasing a rate of data transmission using the selected spread spectrum transmission technique.

20. The method of claim 16, wherein the electronic circuit comprises: a voltage source, a first conductive element, a receiving unit, and a second conductive element, wherein the voltage source, the first conductive element, the receiving unit, and the second conductive element are electrically coupled in series; one or more resistors in parallel with the receiving unit, electrically spanning the first conductive element and the second conductive element; and one or more transient short components, each transient short component comprising a switch electrically in series with a resistor and a capacitor wired in parallel, and each transient short component electrically spanning the first conductive element and the second conductive element.
